(19) United States
(12) Patent Application Publication
(10) Pub. No.: US 2007/0141881 A1
(43) Pub. Date: Jun. 21, 2007

(54) Image pickup apparatus and data processing apparatus having the same

(75) Inventor: Kwang-Hee Lee, Anyang-si (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 11/606,276

(22) Filed: Nov. 30, 2006

(30) Foreign Application Priority Data
Dec. 19, 2005 (KR) 10-2005-0125477

(51) Int. Cl. H01R 3/08

(52) U.S. Cl. 439/179

(57) ABSTRACT

An image pickup apparatus may include an image sensor that may be mounted on a substrate. A frame member may be fixed to an upper surface of the substrate. An optical member may be inserted in the frame member such that the optical member may be spaced apart from an upper surface of the image sensor. A cover member may be coupled to the frame member. A first elastic member may be connected to the optical member to control the position of the optical member between the cover and the image sensor.

### PRIORITY STATEMENT

This U.S. non-provisional application claims the benefit of priority under 35 U.S.C. §119 from Korean Patent Application No. 10-2005-125477, filed on Dec. 19, 2005, in the Korean Intellectual Property Office (KIPO), the entire contents of which is incorporated herein by reference.

### BACKGROUND

1. Field

Example, non-limiting embodiments relate to an image pickup apparatus and a data processing apparatus having the same.

2. Description of the Related Art

In an image pickup apparatus, a distance between an image sensor and a lens may need to be maintained constant to maintain a constant focal length. For this purpose, in a conventional image pickup apparatus, a lens frame may be fixed to a substrate using an adhesive. An image sensor may be mounted thereon. The lens frame, the range sensor, and a lens holder for fixing a lens may be coupled to each other with screws, so that a lens may move vertically with respect to the image sensor, which may determine a distance between the lens and the image sensor. Such a conventional image pickup apparatus is disclosed in U.S. Pat. No. 6,900,913. However, according to such a conventional image pickup apparatus, the screw coupling may be performed by a manual process, which may lengthen the manufacturing time. Further, a focal length may be controlled by an operator, thus it may be difficult to control precisely the focal length.

In another conventional image pickup apparatus, a lens holder may be inserted on an inner periphery of a lens frame and may contact an upper surface of an image sensor through a leg portion of the lens holder. The lens holder may be pressed toward the image sensor by a coil that may be located on an upper surface of the lens holder, which may determine a distance between a lens and the image sensor. Such a conventional image pickup apparatus is disclosed in U.S. Pat. No. 6,891,679. However, according to such a conventional image pickup apparatus, the leg portion of the lens holder may directly contact the upper surface of the image sensor. Therefore, if an external force or shock is applied to the image pickup apparatus, either artificially for an experimental purpose or accidentally caused by careless management, the coil may exert a force on the lens holder. Correspondingly, the leg portion of the lens holder may be exert a force on an upper surface of the image sensor, which may, for example, damage the image sensor or change the focal length.

### SUMMARY

Example, non-limiting embodiments may provide an image pickup apparatus that may protect an image sensor from a force or shock.

Example, non-limiting embodiments may provide an image pickup apparatus that may be more easily assembled in comparison with a conventional screw coupling.

Example, non-limiting embodiments may provide an image pickup apparatus that may maintain a fixed distance between a lens and an image sensor.

In an example, non-limiting embodiment, and image pickup apparatus may include an image sensor mounted on a substrate. A frame member may be fixed on an upper surface of the substrate. An optical member may be inserted in the frame member such that the optical member is spaced apart from an upper surface of the image sensor. A cover member may be coupled to the frame member. An elastic member may be connected to the optical member to control the position of the optical member between the cover member and the image sensor.

According to an example, non-limiting embodiment, the first elastic member may be interposed between the optical member and the upper surface of the substrate.

According to an example, non-limiting embodiment, the optical member may include a lens for condensing light incident on the image sensor; and a lens holder that may support the lens, the lens holder may have a contact portion that may contact the elastic member and at least one first protrusion that may contact the cover member.

According to an example, non-limiting embodiment, the elastic member may be one of a coil, a sponge, a resin, and an elastic material including resin, urethane, and metal.

According to an example, non-limiting embodiment, the at least one first protrusion may be integrally formed along one end of the lens holder.

According to an example, non-limiting embodiment, the at least one first protrusion may be a plurality of first protrusions spaced apart from each other at one end of the lens holder.

According to an example, non-limiting embodiment, the frame member may include a supporting part protruding from an inner peripheral surface of the frame member, and wherein the optical member may include a second protrusion that may contact the supporting part of the frame member.

According to an example, non-limiting embodiment, the second protrusion may be configured to enclose the elastic member so as to reduce a horizontal movement of the elastic member.

According to an example, non-limiting embodiment, a data processing apparatuses may include a processor; and an image pickup apparatus that may be operationally coupled to the processor.

According to an example, non-limiting embodiment, the elastic member may be interposed between the optical member and the cover member.

According to an example, non-limiting embodiment, the frame member may have a supporting part, and the optical member may include a lens for condensing light incident on the image sensor; and a lens holder that may support the lens, the lens holder may have a contact portion contacting the first elastic member and at least one first protrusion that may contact the supporting part of the frame member.

According to an example, non-limiting embodiment, the elastic member may be one of a coil, a sponge, and an elastic material including resin, urethane, and metal.

According to an example, non-limiting embodiment, the at least one first protrusion may be integrally formed along one end of the lens holder.

According to an example, non-limiting embodiment, the at least one first protrusion may be a plurality of first protrusions spaced apart from each other at one end of the lens holder.

According to an example, non-limiting embodiment, the supporting part of the frame member may be integrally formed along an inner peripheral surface of the frame member.

According to an example, non-limiting embodiment, the elastic member may comprise a first elastic member interposed between the optical member and the cover member and a second elastic member interposed between the optical member and the upper surface of the substrate.

According to an example, non-limiting embodiment, the first elastic member and the second elastic member may independently comprise one of a coil, a sponge, and an elastic material including resin, urethane, and metal.

According to an example, non-limiting embodiment, the optical member may include a second protrusion and extending to the cover member.

According to an example, non-limiting embodiment, a data processing apparatuses may include a processor; and an image pickup apparatus that may be operationally coupled to the processor.

### BRIEF DESCRIPTION OF THE DRAWINGS

Example, non-limiting embodiments will be described with reference to the accompanying drawings.

FIG. 1 is a sectional view of an image pickup apparatus of an example, non-limiting embodiment, taken along a direction in which light may be incident to the image pickup apparatus.

FIGS. 2A and 2B are example cross-sectional views, taken along a line I-I′, of a frame member of the image pickup apparatus of FIG. 1.

FIG. 3 is an example exploded perspective view of a coupling between an elastic member and an optical member of the image pickup apparatus of FIG. 1.

FIG. 4 is a sectional view of an image pickup apparatus, according to an example, non-limiting embodiment, taken along a direction in which light may be incident to the image pickup apparatus.

FIG. 5 is an example schematic view of a coupling between an image sensor and an elastic member of the image pickup apparatus of FIG. 4.

FIG. 6 is an example exploded perspective view of a coupling between an elastic member and an optical member of the image pickup apparatus of FIG. 4.

FIG. 7 is a schematic sectional view of an image pickup apparatus according to an example, non-limiting embodiment.

FIG. 8 is a schematic sectional view of an image pickup apparatus according to an example, non-limiting embodiment.

FIG. 9 is an example sectional view of an optical member of the image pickup apparatus of FIG. 8.

FIGS. 10A and 10B are a perspective view and a cross-sectional view, respectively, of a coupling between an optical member and a frame member according to an example, non-limiting embodiment.

FIGS. 11A and 11B are a perspective view and a cross-sectional view, respectively, of a coupling between an optical member and a frame member according to an example, non-limiting embodiment.

FIG. 12 is a schematic block diagram of a data processing apparatus having an image pickup apparatus according to an example, non-limiting embodiment.

### DESCRIPTION OF EXAMPLE, NON-LIMITING EMBODIMENTS

Reference will now be made in detail to example non-limiting embodiments, examples of which are illustrated in the accompanying drawings. Example embodiments are not limited to the example embodiments illustrated herein after. Rather, the example embodiments herein are introduced to provide easy and complete understanding of the scope and spirit of the present invention.

In the drawings, the size and the relative size of a member, a component, and an element may be exaggerated for clarity. Also, the shape of a member, a component, or an element illustrated in the drawings may change more or less due to modification of a manufacturing process. Therefore, example embodiments disclosed in the specification should riot be limited to a shape illustrated in the drawings and should be understood as including modification to some extent unless otherwise indicated.

It will be understood that when a feature or an element is referred to as being “on,” “connected to” or “coupled to” another feature or element, it can be directly on, connected or coupled to the other feature or element or intervening features or elements that may be present. In contrast, when an element is referred to as being “directly on,” “directly connected to” or “directly coupled to” another feature or element, there are no intervening features or elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer and/or section discussed below could be termed a second element, component, region, layer or section without departing from the teachings of the example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

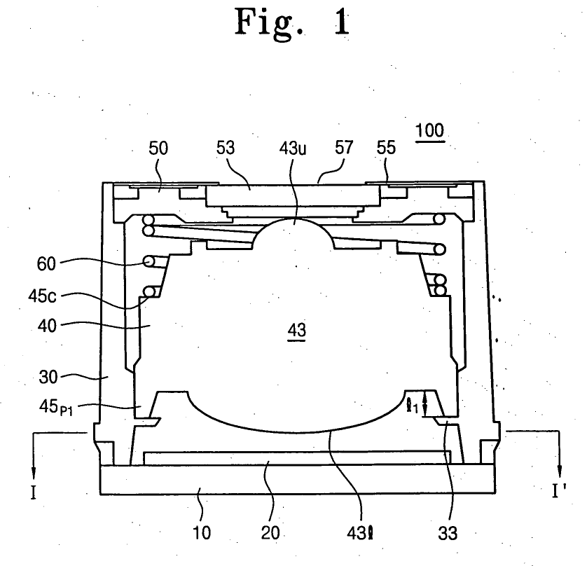

FIG. 1 is a sectional view of an image pickup apparatus according to an example, non-limiting embodiment, taken along a direction in which light may be incident to an image pickup apparatus. Referring to FIG. 1, an image pickup apparatus 100 may include a substrate 10, an image sensor 20, a frame member 30, an optical member 40, a cover member 50, and/or an elastic member 60. For example, the substrate 10 may be a printed circuit board (PCB). For example, the image sensor 20 may be a complementary metal oxide semiconductor (CMOS) or a charged coupled device (CCD), and may be mounted on the substrate 10. The image sensor 20 may include a photoelectric conversion part where pixels may be arranged, and a peripheral circuit part that may be formed around the photoelectric conversion part. Pads may be arranged on an outer edge of the peripheral circuit part, and the pads may be electrically connected to a circuit of the substrate 10.

For example, the substrate 10 may be electrically connected to a flexible PCB (FPCB) through a suitable method. The FPCB may be connected to a connector, which may be connected to a data processing apparatus, for example, a portable phone.

The frame member 30 may be attached and fixed in place on an upper surface of the substrate 10, and has may have a supporting part 33 for supporting the optical member 40. The supporting part 33 may have a predetermined or given height from the upper surface of the substrate 10. A distance between the image sensor 20 and the optical member 40 may depend on the height of the supporting part 33 of the frame member 30. The supporting part 33 of the frame member 30 may protrude into an inner cavity from an inner peripheral surface of the frame member 30. An inner peripheral surface of the frame member 30 may have a shape corresponding to a shape of an outer surface of the optical member 40 which may be inserted into the inner cavity of the frame member 30. For example, if the outer surface of the optical member 40 is circular, the inner peripheral surface of the frame member 30 may also be circular. However, a shape of an outer peripheral surface of the frame member 30 may be entirely independent from the shape of the optical member 40. For example, the outer peripheral surface of the frame member 30 may have a circular shape or may have a polygonal shape, for example a quadrangular shape.

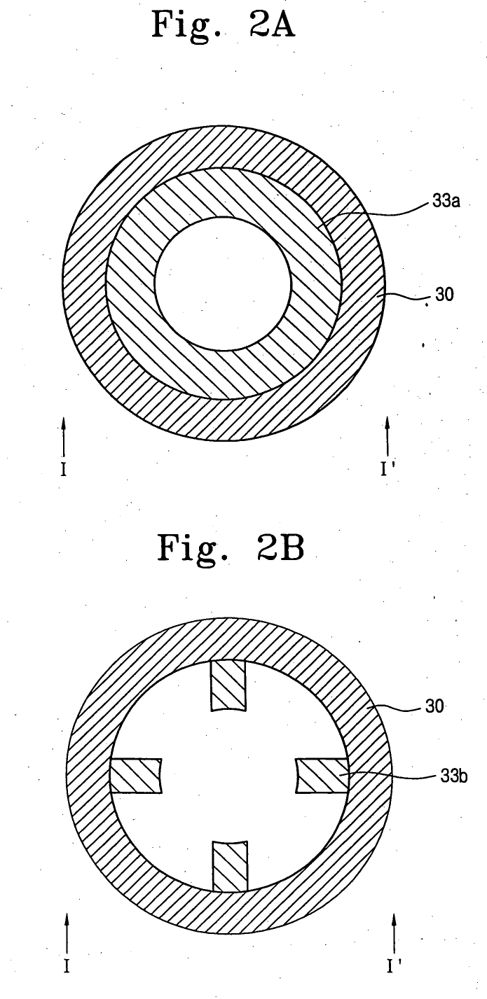

FIGS. 2A and 2B are example cross-sectional views, taken along a line I-I′ of FIG. 1, of example non-limiting embodiments of the supporting part 33 of the frame member 30. The frame member 30 may have a ring-type supporting part 33a that may be continuously formed along a circular inner peripheral surface of the frame member 30. The frame member 30 may have a plurality of supporting parts 33b (e.g., four supporting parts) that may be spaced apart from each other along the circular inner peripheral surface of the frame member 30. For example, an outer peripheral surface of the frame member 30 may be circular or may have a polygonal shape, for example, a quadrangular shape.

Referring again to FIG. 1, the optical member 40 may be inserted into the frame member 30. The optical member 40 may include a lens 43 for condensing light incident onto the image sensor 20, and a lens holder 45 for fixing the lens 43. For example, the lens 43 may be formed of transparent glass or plastic material. The lens 43 may include a first lens 43u located on an upper side (e.g., a side to which light is incident) and a second lens 431 located on a lower side (e.g., a side close to the image sensor). The number of lenses may be one or more. The lens holder 45 may have a contact portion 45c that may contact an elastic member 60. The lens holder 45 may have a first protrusion 45_{P1} that may extend toward the substrate 10 and may be seated on the supporting part 33 of the frame member 30.

The first protrusion 45_{P1} may be a ring-type member that may be continuously formed along the lower outer peripheral surface of the optical member 40. Alternately, a plurality of first protrusions 45_{P1} may be spaced apart from each other along a lower outer peripheral surface of the optical member 40. For example, a lower surface of the first protrusion 45_{P1} that may be seated on and contacting the supporting part 33 of the frame member 30 may be located above or within the image sensor 20.

The shape and the number of the first protrusions 45_{P1} may not be dependent on the shape and the number of the supporting part 33 of the frame member 30. For example, if the frame member 30 has a continuous ring type supporting part 33a, the optical member 40 may have a continuous ring type first protrusion or a plurality of protrusions spaced from each other. Likewise, if the frame member 30 has a plurality of supporting parts 33b, the optical member 40 can have a continuous ring type first protrusion or a plurality of protrusions spaced from each other.

The cover member 50 may be coupled to a front end of the frame member 30 that does not contact the substrate 10. For example, the cover member 50 may be inserted into an opening formed in an upper side of the frame member 30 (e.g., in a front end at a portion to which light is incident) and coupled to the frame member 30. Alternatively, the cover member 50 may be integrally formed with the frame member 30. Accordingly, the optical member 40 may be located in an inner cavity defined by the frame member 30, the substrate 10, and the cover member 50.

An elastic member 60 may be located between the cover member 50 and the optical member 40. For example, the elastic member 60 may be a coil or a sponge, but is not limited thereto. The elastic member 60 may be formed of a resin, a urethane or an elastic material that may endure stable elastic force for a long period of time. If the cover member 50 is inserted into the frame member 30, the elastic member 60 may press the optical member 40 toward the substrate 10 such that the first protrusion 45_{P1} of the optical member 40 may be contact the supporting part 33 of the frame member 30. Thus, a position of the optical member 40 may be fixed.

The cover member 50 may have a filter 53 and a light-blocking plate 55. The cover member may have an opening 57 that may control an amount of light incident to the optical member 40 by using the light-blocking plate 55. For example, the filter 53 may be formed of a material having an infrared absorption characteristic.

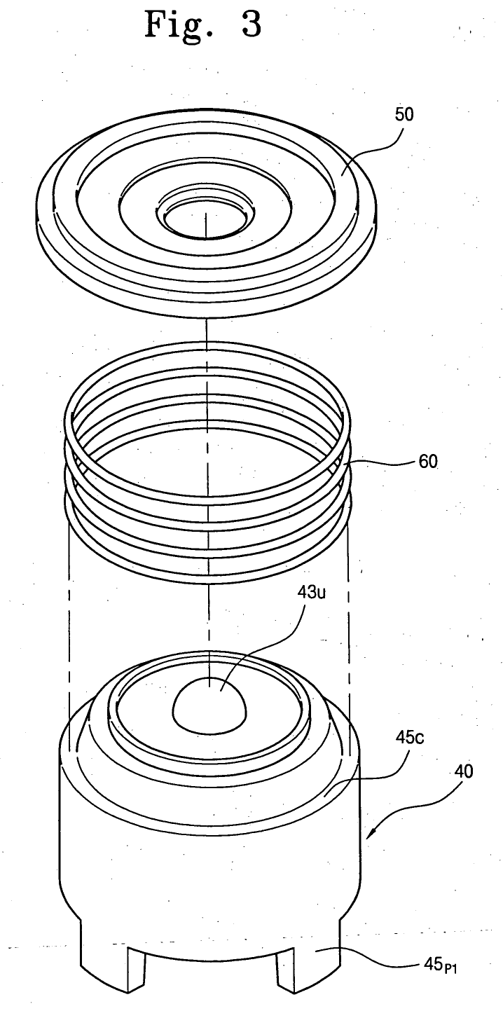

FIG. 3 is an example exploded perspective view of a coupling between the elastic member 60 and the optical member 40 of the image pickup apparatus 100 of FIG. 1.

Referring to FIG. 3, the contact portion 45c may be formed on an upper surface of the optical member 40. The first protrusion 45_{P1} may be located on a lower side of the optical member 40 from the contact portion 45c. The elastic member 60 may be interposed between the optical member 40 and the cover member 50, and may contact the contact portion 45c of the optical member 40.

According an example, non-limiting embodiment, the optical member 40 may be attached and fixed in place on the supporting part 33 of the frame member 30 by the elastic member 60. The cover member 50 may be provided on the elastic member 60 and may press the elastic member 60 towards the optical member 40. Therefore, if an external force or shock is applied to the image pickup apparatus 100, the force may be transferred to the supporting part 33 of the frame member 30 or the substrate 10. In this way, the image sensor 20 may be protected.

According to an example, non-limiting embodiment, an image pickup apparatus having a constant focal length may be more easily assembled in comparison with a conventional screw coupling.

In example, non-limiting embodiments, a distance between the lens 43 and the image sensor 20 may be controlled by controlling a height of the supporting part 33 of the frame member 30 and/or a length l1 of the first protrusion 45_{P1} of the optical member 40.

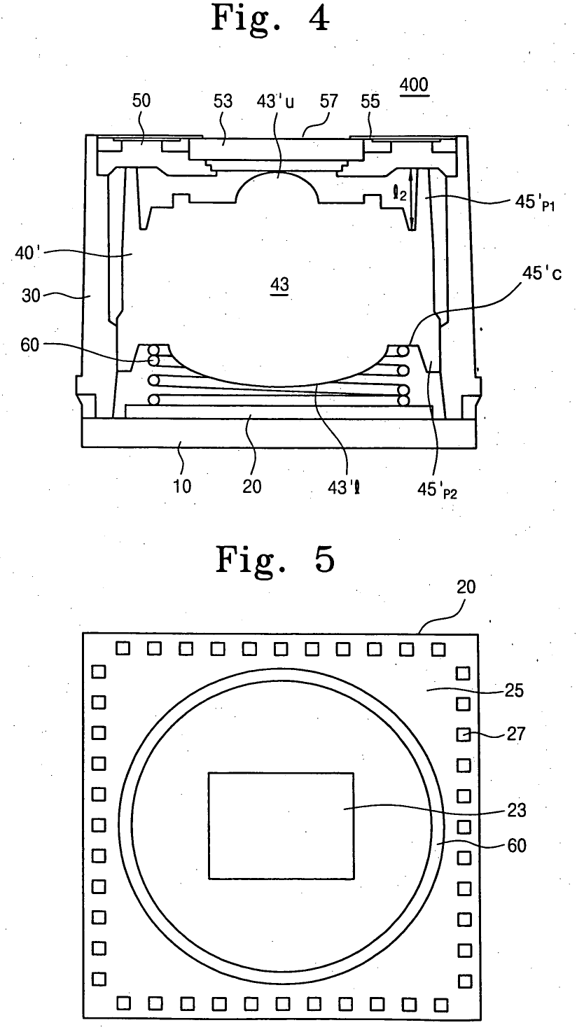

FIG. 4 is a sectional view of an image pickup apparatus according to an example, non-limiting embodiment, taken along a direction in which light is incident to an image pickup apparatus.

Referring to FIG. 4, unlike the image pickup apparatus 100 described with reference to FIG. 1, an image pickup apparatus 400 may include an elastic member 60 that may be interposed between an optical member 40′ and an upper surface of an image sensor 20. The optical member may have a first protrusion 45′_{P1} that may be formed on an upper surface of the optical member 40′ and that may contact a cover member 50. A contact portion 45′c that may be formed on a lower surface of the optical member 40′ facing the image sensor 20 may contact the elastic member 60.

A length l2 of the first protrusion 45′_{P1} may serve as a factor determining a distance between a lens 43 and the image sensor 20. A plurality of first protrusions 45′_{P1} may be formed along an upper outer peripheral surface of the optical member 40′ and may be spaced apart by a constant interval. The first protrusion 45′_{P1} may be disc-shaped or ring-shaped and may be continuously formed along the upper outer periphery of the optical member 40′.

The elastic member 60 may be interposed between the contact portion 45′c of the optical member 40′ and the upper surface of the image sensor 20. The elastic member 60 may press the optical member 40′ toward the cover member 50, so that the optical member 40′ may be fixed to the cover member 50. For example, if the cover member 50 is inserted into the frame member 30, the cover member 50 may press the first protrusion 45′_{P1} of the optical member 40′ toward a substrate 10. The elastic member 60 interposed between the upper surface of the image sensor 20 and the optical member 40′ may repulse with elastic force of its own against pressure by the cover member 50, and this repulsive force may press the optical member 40′ toward the cover member 50. Accordingly, the optical member 40′ may be attached and fixed in place on a lower surface of the cover member 50, and a distance between the optical member 40′ and the image sensor 20 may be maintained constant.

FIG. 5 is an example schematic view of a coupling between the image sensor 20 and the elastic member 60. Referring to FIG. 5, an image sensor 20 may include a photoelectric conversion part 23 and a peripheral circuit part 25. Pads 27 may be located along an outer edge of the peripheral circuit part 25. An elastic member 60 may contact the peripheral circuit part 25 between the photoelectric conversion part 23 and the pads 27.

According to an example, non-limiting embodiment, the elastic member 60 may be located between a lower surface of the optical member 40′ and an upper surface of the image sensor 20. Therefore, if an external force or shock is applied to the image pickup apparatus 400, the elastic member 60 may prevent the force or shock from being exerted on the image sensor 20. In this way, the image sensor 20 may be protected.

In example, non-limiting embodiments, a distance between the lens 43 and the image sensor 20 may be controlled by controlling a length l2 of the first protrusion 45′_{P1} of the optical member 40′.

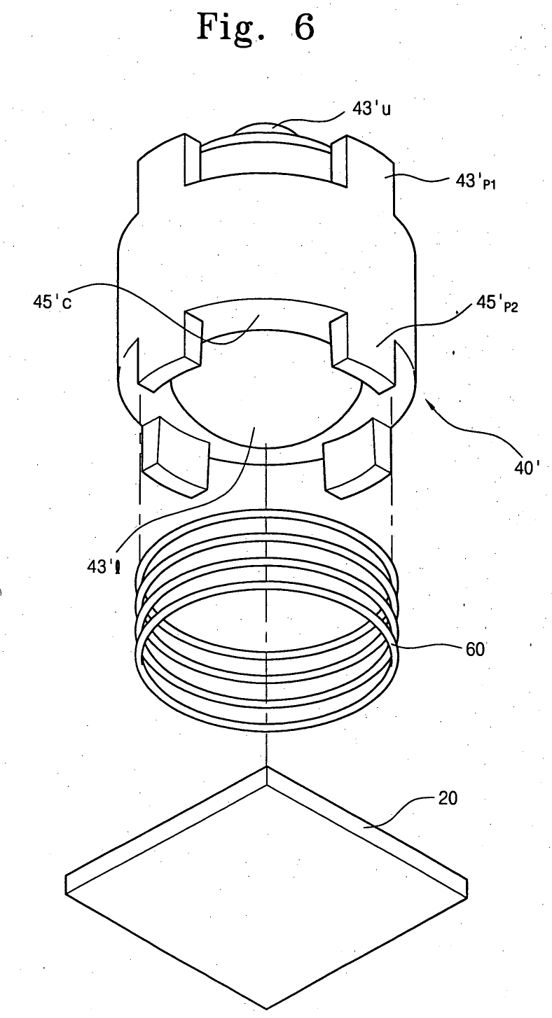

FIG. 6 is an example exploded perspective view of a coupling between the elastic member 60 and an optical member 40′ of the image pickup apparatus 400 of FIG. 4.

Referring to FIG. 6, the first protrusion 45′_{P1} of the optical member 40′ may extend toward and may contact the cover member 50. The contact portion 45′c of the optical member 40′ may contact the elastic member 60, which may be interposed between an upper surface of the image sensor 20 and a lower surface of the optical member 40′.

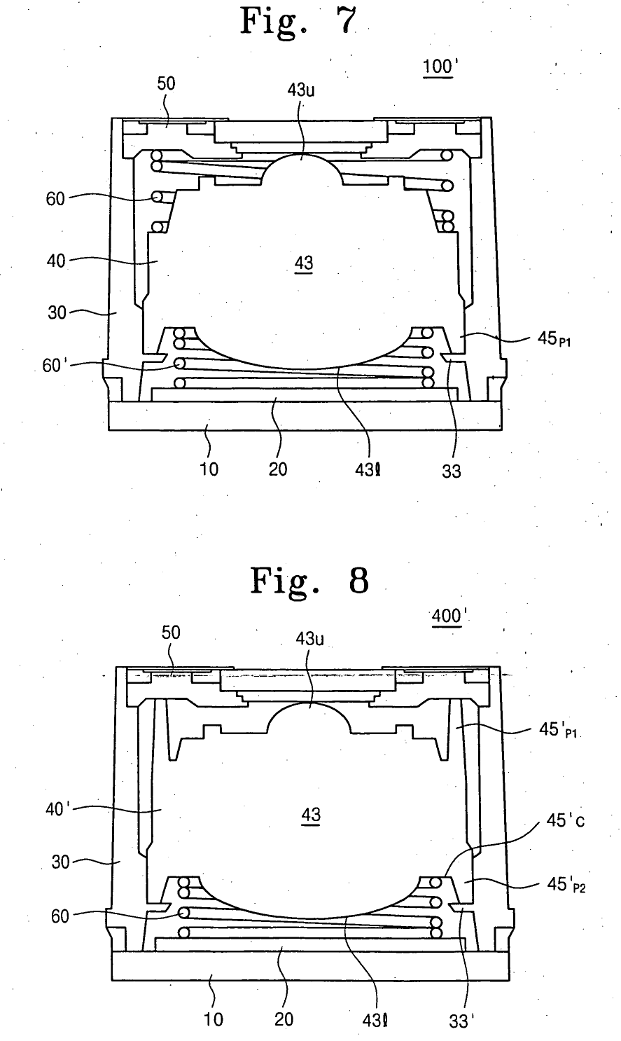

FIG. 7 is a sectional view of an image pickup apparatus according to an example, non-limiting embodiment. Referring to FIG. 7, the image pickup apparatus 100′ may include a second elastic member 60′ interposed between an optical member 40 and an upper surface of an image sensor 20. In this embodiment, a first protrusion 45_{P1} may also serves to prevent the second elastic member 60′ from moving.

FIG. 8 is a schematic sectional view of an image pickup apparatus 400′ according to an example, non-limiting embodiment, including a modification of the image apparatus 400 described with reference to FIGS. 4 to 6.

Referring to FIG. 8, an optical member 40′ may further include a second protrusion 45′_{P2}. For example, the second protrusion 45′_{P2} may protrude toward a substrate 10 and may be formed on an outer edge of a contact portion 45′c of the optical member 40′. If the elastic member 60 contacts the contact portion 45′c, the second protrusion 45′_{P2} may reduce the horizontal movement of the elastic member 60. For example, the second protrusion 45′_{P2} may correspond to the first protrusion 45_{P1} of the image pickup apparatus 100 of FIG. 1.

A frame member 30 may further include a supporting part 33′. The supporting part 33′ may extend from an inner peripheral surface of the frame member 30. If the frame member 30 includes a supporting part 33′, the second protrusion 45′_{P2} of the optical member 40 may be seated on the supporting part 33′. For example, the supporting part 33′ may correspond to the supporting part 33 of FIG. 1.

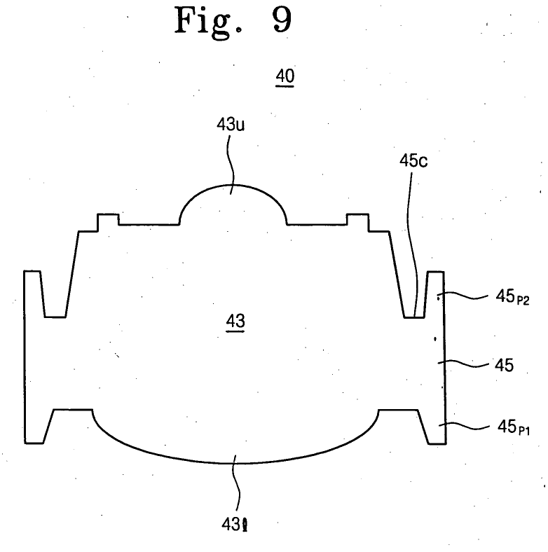

FIG. 9 is an example sectional view of an optical member of the image pickup apparatus of FIG. 8. Referring to FIG. 9, a second protrusion 45_{P2} may be provided on an outer edge of the contact portion 45c of the optical member 40. An upper surface of the second protrusion 45_{P2} may be formed higher than an upper surface of the contact portion 45c in order to properly perform a function thereof. The upper surface of the second protrusion 45_{P2} may extend to contact the cover member 50.

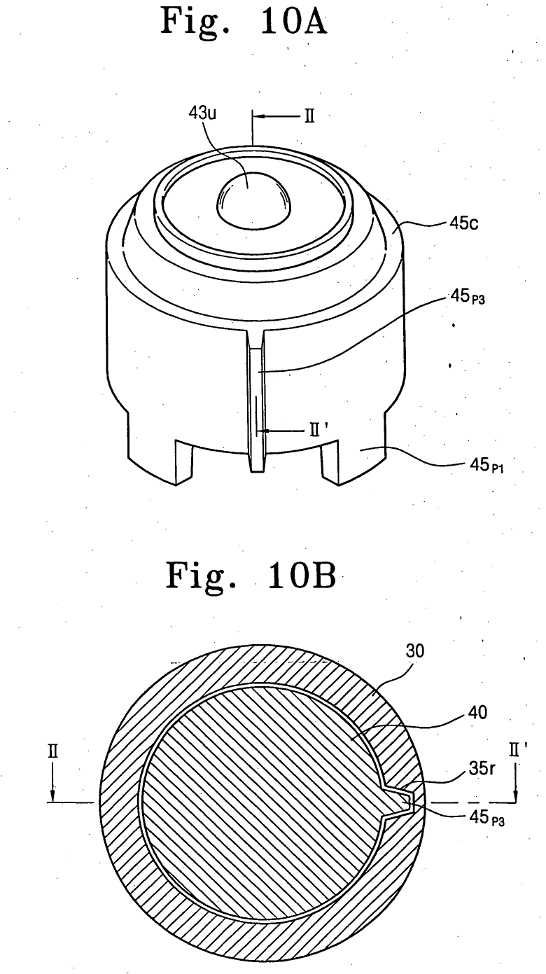

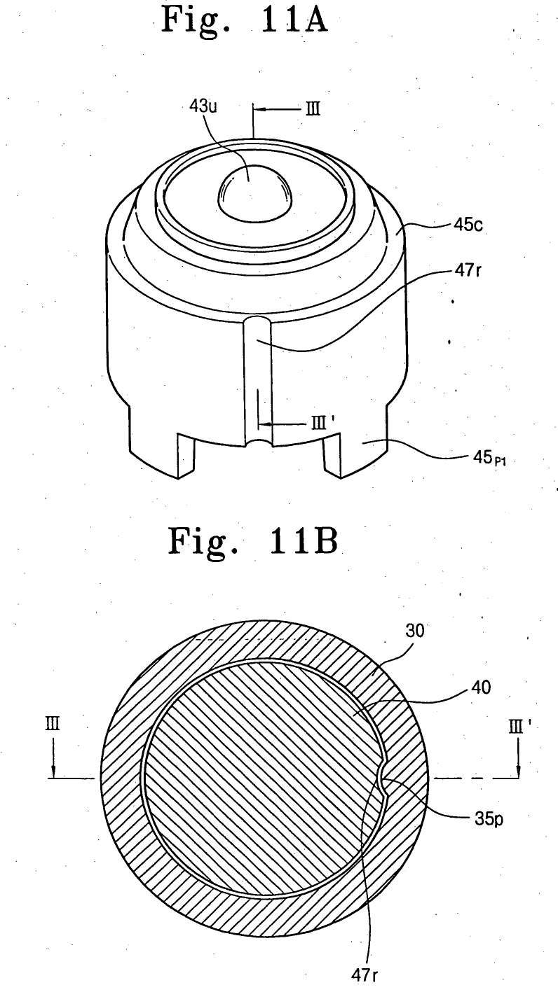

To reduce movement of the optical member 40 that may be inserted into the frame member 30, the optical member 40 and the frame member 30 may form a unique coupling. Example, non-limiting embodiments of a coupling between the optical member 40 and the frame member 30 will be described with reference to FIGS. 10A, 10B, 11A, and 11B.

FIG. 10A is a schematic perspective view of an optical member 40 having a protrusion 45_{P3} (referred to as a “horizontal protrusion” for convenience) protruding toward an inner peripheral surface of the frame member 30 according to an example, non-limiting embodiment. FIG. 10B is an example cross-sectional view taken along a line II-II′ of FIG. 10A. Referring to FIGS. 10A and 10B, the optical member 40 may include a horizontal protrusion 45_{P3} that may be formed on a lateral surface of the optical member 40. This horizontal protrusion 45_{P3} may extend toward an inner cavity from the lateral surface of the optical member 40. The frame member 30 may include a concave portion 35r that may be corresponding to the horizontal protrusion 45_{P3} of the optical member 40. The horizontal protrusion 45_{P3} of the optical member 40 may be inserted into the concave portion 35r that may be formed in an inner peripheral surface of the frame member 30. The number of horizontal protrusions 45_{P3} and concave portions 35r are not limited and may be variously set for safe coupling between the optical member 40 and the frame member 30.

FIG. 11A is a schematic perspective view of an optical member 40 that may include a concave portion and a frame member 30 that may include a protrusion corresponding to the concave portion, according to an example, non-limiting embodiment. FIG. 11B is a cross-sectional view taken along a line III-III′ of FIG. 11A. Referring to FIGS. 11A and 11B, the optical member 40 may include a concave portion 47r formed in a lateral side of the optical member 40. The frame member 30 may include a protrusion 35p that may protrude from an inner peripheral surface of the frame member 30 and may extend toward an inner cavity of the frame member 30. If the optical member 40 is inserted into the frame member 30, the concave portion 47r of the optical member 40 may receive the protrusion 35p of the frame member 30. The number of concave portions 47r and protrusions 35p are not limited and may be variously set for safe coupling between the optical member 40 and the frame member 30.

The above-described example, non-limiting embodiments of a coupling between the optical member 40 and the frame member 30 may be similarly applied to a coupling between the frame member 30 and the cover member 50.

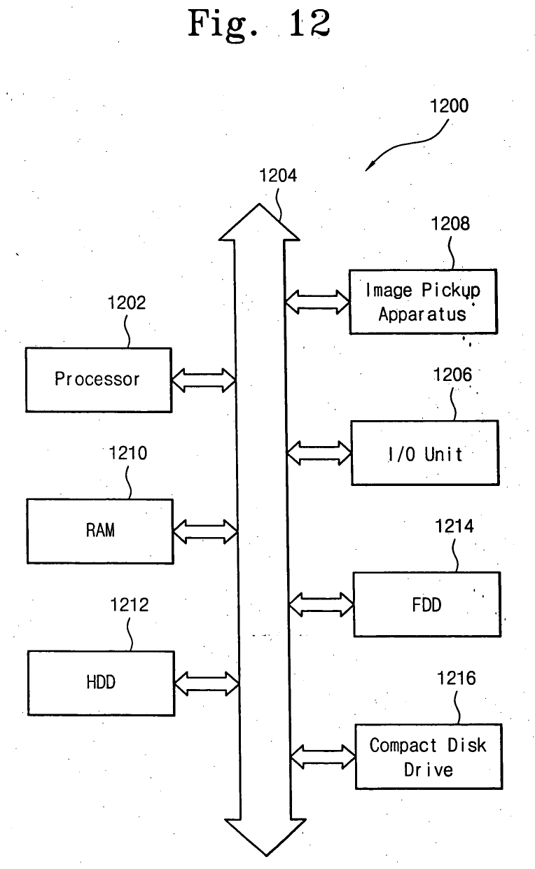

The image pickup apparatus according to an example, non-limiting embodiment may be operationally coupled to a data processing apparatus, for example, a portable phone, through an appropriate means, for example, a FPCB. FIG. 12 is a block diagram of a data processing apparatus 1200 having an image pickup apparatus according to an example, non-limiting embodiment. The data processing apparatus 1200 having an image pickup apparatus according to an example non-limiting embodiment may be, but is not limited to, for example, a computer system, a camera system, a personal digital assistant (PDA), an audio/video (AV) apparatus, a camcorder, an optical mouse, a biometric system such as a fingerprint recognition system, a television, a scanner, a video telephone, an electronic surveillance system, a machine vision system, a vehicle navigation system, an auto-focusing system, a star tracking system, a motion detecting system, an image stabilizing system, an image data compression system, and any data processing apparatus that may use an image pickup apparatus according to an example non-limiting embodiment.

Referring to FIG. 12, the data processing apparatus 1200 may include a processor 1202 that may communicate with variety of devices via a bus 1204. One or more device that may be connected to the bus 1204, for example, an input/output (I/O) unit 1206 and/or an image pickup apparatus 1208, may provide input/output communication to/from the data processing apparatus 1200. One or more device that may be connected to the bus 1204 may be peripheral memory devices, for example, random access memories (RAMs) 1210, hard disk drives (HDDs) 1212, floppy disk drives (FDDs) 1214, and compact disk drives 1216. An image sensor of the image pickup apparatus 1208 may receive a control signal and/or data from the processor 1202 or other devices of the data processing apparatus 1200. The image sensor of the image pickup apparatus 1208 may provide a signal defining an image to the processor 1202 on the basis of the received control signal or data. The processor 1202 may process the signal received from the image sensor of the image pickup apparatus 1208.

According to an example, non-limiting embodiment, if an external force or shock is applied to an image pickup apparatus, a force may be transferred to a substrate and an image sensor may be protected.

According to an example, non-limiting embodiment, if an external force or shock is applied to an image pickup apparatus, a distance between an optical member and an image sensor may be maintained constant.

According to an example, non-limiting embodiment, a distance between a lens and an image sensor may be controlled by controlling a height of a supporting part of a frame member and/or a length of a protrusion of an optical member.

It will be apparent to those skilled in the art that various modifications and variations can be made to the example, non-limiting embodiments. Thus, it is intended that modifications and variations of example, non-limiting embodiments which may appear to those skilled in the art will still come within the spirit and scope of the appended claims.

What is claimed is:

1. An image pickup apparatus comprising:
an image sensor mounted on a substrate;
a frame member fixed to an upper surface of the substrate;
an optical member inserted in the frame member such that the optical member is spaced apart from an upper surface of the image sensor;
a cover member coupled to the frame member; and
an elastic member connected to the optical member to control the position of the optical member between the cover member and the image sensor.

2. The apparatus of claim 1, wherein the elastic member is interposed between the optical member and the upper surface of the substrate.

3. The apparatus of claim 2, wherein the optical member includes
a lens for condensing light incident onto the image sensor; and
a lens holder for supporting the lens, the lens holder having a contact portion contacting the elastic member and at least one first protrusion contacting the cover member.

4. The apparatus of claim 1, wherein the elastic member is one of a coil, a sponge, and an elastic material including resin, urethane, and metal.

5. The apparatus of claim 3, wherein the at least one first protrusion is integrally formed along one end of the lens holder.

6. The apparatus of claim 3, wherein the at least one first protrusion is a plurality of first protrusions spaced apart from each other at one end of the lens holder.

7. The apparatus of claim 3, wherein the frame member includes a supporting part protruding from an inner peripheral surface of the frame member; and wherein the optical member includes a second protrusion contacting the supporting part of the frame member.

8. The apparatus of claim 7, wherein the second protrusion is configured to enclose the elastic member so as to reduce a horizontal movement of the elastic member.

9. A data processing apparatus comprising:
a processor; and
the image pickup apparatus of claim 2 operationally coupled to the processor.

10. The apparatus of claim 1, wherein the elastic is interposed between the optical member and the cover member to fix the optical member to the supporting part of the frame member.

11. The apparatus of claim 10, wherein the frame member has a supporting part, and wherein the optical member includes
a lens for condensing light incident on the image sensor; and
a lens holder for supporting the lens, the lens holder having a contact portion contacting the elastic member and at least one first protrusion contacting the supporting part of the frame member.

12. The apparatus of claim 10, wherein the elastic member is one of a coil, a sponge, and an elastic material including resin, urethane, and metal.

13. The apparatus of claim 11, wherein the at least one first protrusion is integrally formed along one end of the lens holder.

14. The apparatus of claim 11, wherein the at least one first protrusion is a plurality of first protrusions spaced apart from each other at a one end of the lens holder.

15. The apparatus of claim 11, wherein the supporting part of the frame member is integrally formed along an inner peripheral surface of the frame member.

16. The apparatus of claim 1, wherein the elastic member comprises a first elastic member interposed between the optical member and the cover member and a second elastic member interposed between the optical member and the upper surface of the substrate.

17. The apparatus of claim 16, wherein the first and second elastic members independently comprise a coil, a sponge, an elastic material including resin, urethane, or metal.

18. The apparatus of claim 16, wherein the frame member has a supporting part, and wherein the optical member includes:
a lens for condensing light incident on the image sensor; and
a lens holder for supporting the lens, the lens holder having at least one first protrusion contacting the supporting part of the frame member.

19. The apparatus of claim 11, wherein the optical member further includes a second protrusion extending to the cover member.

20. A data processing apparatus comprising:
a processor; and
the image pickup apparatus of claim 10 operationally coupled to the processor.
